(19) United States
(12) Patent Application Publication
(10) Pub. No.: US 2003/0055971 A1
(43) Pub. Date: Mar. 20, 2003

(54) Providing load balancing in delivering rich media

(76) Inventor: Rama R. Menon, Portland, OR (US)

Correspondence Address: FISH & RICHARDSON, PC, 4350 LA JOLLA VILLAGE DRIVE, SUITE 500, SAN DIEGO, CA, 92122, US

(21) Appl. No.: 09/957,638

(22) Filed: Sep. 19, 2001

(51) Int. Cl. G06F 15/173

(52) U.S. Cl. 709/226

(57) ABSTRACT

Providing load balancing in delivering rich media includes monitoring bandwidth usage on each link between a switching device and each of a plurality of servers, monitoring an amount of information being transmitted on each link, and considering the bandwidth usage and the amount of information in choosing one of the servers to stream rich media information across a network to a destination.

### BACKGROUND

This invention relates to providing load balancing in delivering rich media.

In networks such as the Internet, servers receive requests for information from clients and send the requested information back to the clients. Servers typically have capability limits on the number of requests that any given server can simultaneously handle. The number of requests may exceed the capability limits of a server and create a capacity problem.

One way to solve the capacity problem is to provide a set of identical servers all having access to the same information and all able to answer requests from clients. The servers may be connected to a switching device, such as a layer 2/4 device, that acts to distribute the requests among the servers. When a layer 2/4 device is used to provide such load balancing among these servers, the servers form a virtual server. To answer requests from clients, the virtual server typically exposes a virtual Internet Protocol (IP) address to which the clients may direct their requests. The layer 2/4 device may then perform load balancing to determine which of the servers should answer a particular request sent to the virtual IP address.

One example of a load balancing scheme that the layer 2/4 device may use includes round-robin request forwarding. In round-robin request forwarding, the layer 2/4 device forwards each successive request to successive servers. For example, if the virtual servers includes three servers, the layer 2/4 device may forward request number one to server number one, request number two to server number two, request number three to server number three, request number four to server number one, and so on.

Another example of a load balancing scheme includes the least connections forwarding. In this scheme, the layer 2/4 switch forwards an incoming request to the one of the servers with the least number of existing client connections serving client requests.

### DESCRIPTION OF DRAWINGS

FIG. 1 is a simplified network configuration.

FIG. 2 is a flowchart showing an information transmission process.

FIG. 3 is another simplified network configuration.

### DESCRIPTION

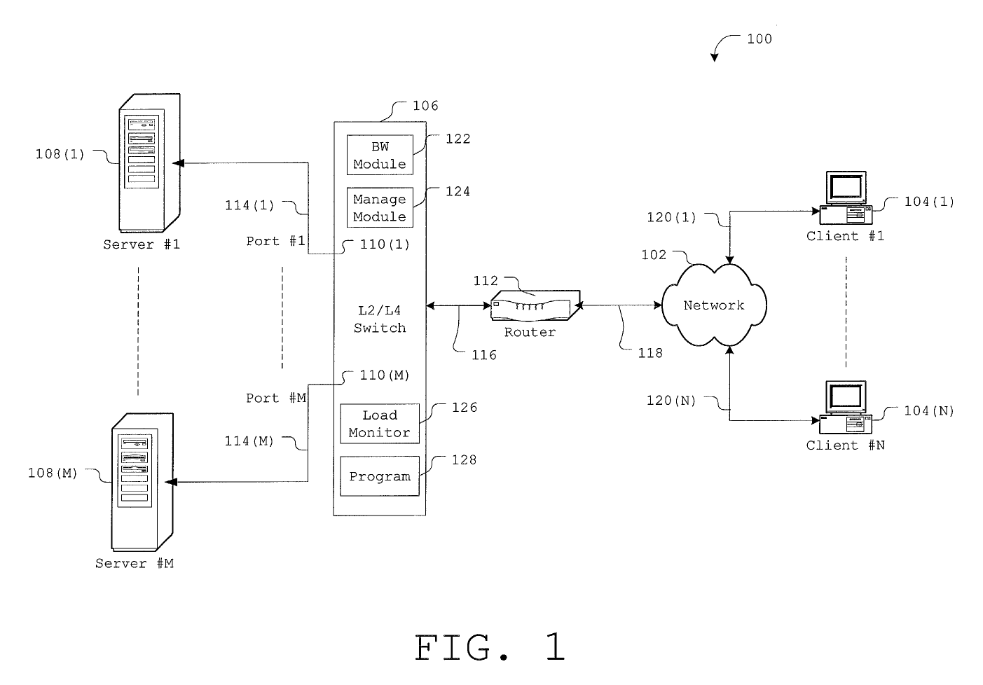

Referring to FIG. 1, in a network configuration 100, one or more servers 108(1)-108(M) distributes information across a network 102 to clients 104(1)-104(N). (M and N each represent a whole number but not necessarily the same whole number; N is typically much larger than M. When one or more of the clients 104(1)-104(N) requests information, a switch 106 can use a program 128 to balance the load among servers 108(1)-108(M) and to select one or more of the servers 108(1)-108(M) to handle the requests from the client(s) 104(1)-104(N). The selected server(s) 108(1)-108(M) transmit the requested information to the switch 106 at ports 110(1)-110(M) associated with the selected server(s) 108(1)-108(M). The switch 106 forwards the information to a router 112 that appropriately routes the information to the clients 104(1)-104(N) (or the information's next stop) over the network 102.

In balancing the load among the servers 108(1)-108(M), the program 128 may consider factors such as server load (e.g., central processing unit (CPU) load, input/output (I/O) load, and/or other similar loads), bandwidth consumption or usage per port or in aggregate on all of the ports 110(1)-110(M), server capacity, server or connection classification, connection speed of the clients 104(1)-104(N), geographic location of the servers 108(1)-108(M), geographic location of the clients 104(1)-104(N), and/or other similar factors.

Various components may provide the program 128 with information regarding one or more of these factors. In particular, the program 128 may balance the load considering information provided or enabled by a bandwidth module 122, a management module 124, and/or a load monitor module 126.

The bandwidth module 122 measures actual bandwidth being used on each of the ports 110(1)-110(M). In other words, the bandwidth module 122 can determine the amount of information being transmitted in a specific amount of time (e.g., bits or bytes per second) on each communication link 114(1)-114(M) between the servers 108(1)-108(M) and the switch 106.

The management module 124 can allow a human operator (administrator) and/or an electronic manager to configure server capacities and/or policies applicable to traffic at each of the ports 110(1)-110(M). Server capacity generally refers to the number or amount of clients, a total amount of information, and/or information streams that can be served from a server. A server's capacity may be a fixed number or amount or may be a dynamically adjusted number or amount. Server policies generally refer to guidelines prioritizing or otherwise evaluating a group of servers. One example of a server policy includes ranking servers in order of priority according to one or more factors such as cost, bandwidth, location, and so forth.

The load monitor module 126 can measure a load on each of the servers 108(1)-108(M). The load generally refers to the amount of traffic on each communication link 114(1)-114(M) between the servers 108(1)-108(M) and the switch 106.

Before further discussing how information may flow between the servers 108(1)-108(M) and the clients 104(1)-104(N), the elements in the network configuration 100 are further described. The elements in the network configuration 100 may be implemented in a variety of ways.

The information communicated between the servers 108(1)-108(M) and the clients 104(1)-104(N) can include a packet including a full or partial IP packet (datagram) for some application included at the sender of the packet. The packet can include data (e.g., text, numbers, Boolean content, addresses, graphical content, control information, and the like), instructions (e.g., commands, requests, queries, and the like), or a combination of the two. Each packet may be part of a packet stream, where the packets in the packet stream fit together to form a contiguous group of data/instructions.

The information may include rich media. Rich media generally refers to bandwidth-intensive information, typically information including graphics, audio, video, animation, text, and/or other similar content. Examples of rich media include media-on-demand (MoD), video-on-demand (VoD), news-on-demand (NoD), distance learning, home shopping, training programs, on-line gaming, software distribution, and other types of similar information.

The network 102 can include any kind and any combination of networks such as the Internet, a local network, a private network, a public network, or other similar network.

The servers 108(1)-108(M) can each include any device capable of communicating with the switch 106 and delivering information to at least one of the clients 104(1)-104(N) such as a server, a mobile computer, a stationary computer, or other similar device. The servers 108(1)-108(M) may all be located in the same geographic region or may be located in various, remotely-located geographic regions. Furthermore, the servers 108(1)-108(M) may vary in type from one another. Additionally, each of the servers 108(1)-108(M) may represent a pool of servers. Each pool of servers may be served by the program 128, the bandwidth module 122, the management module 124, and the load monitor module 126 or by their own individual programs, bandwidth modules, management modules, and load monitor modules.

The clients 104(1)-104(N) can each include any device capable of communicating with the network 102 and receiving information from a server. Examples of the clients 104(1)-104(N) may include a mobile computer, a stationary computer, a workstation, a telephone, a television, a pager, a personal digital assistant, a key pad, an audio and/or video player, and other similar devices.

The switch 106 can include a device capable of communicating with the servers 108(1)-108(M) and the router 112 and filtering and/or forwarding information received from the servers 108(1)-108(M). Examples of the switch 106 include a layer four switch, a layer two switch, and other similar devices.

The router 112 can include a device capable of directing information to and/or from the switch 106 and the network 102.

Communication links 114(1)-114(M), 116, 118, and 120(1)-120(N) can each be any kind and any combination of communication links such as modem links, cables, point-to-point links, infrared connections, fiber optic links, cellular links, wireless links such as Bluetooth, satellite links, and other similar links.

The network configuration 100 has been simplified for ease of explanation; the network configuration 100 may include additional elements such as networks, routers, switches, communication links, proxy servers, firewalls or other security mechanisms, Internet Service Providers (ISPs), and other elements.

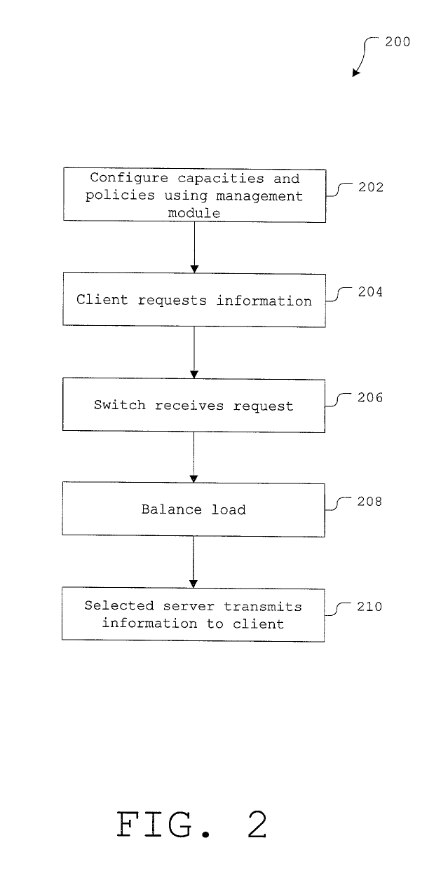

Referring to FIG. 2, a process 200 illustrates an example of information transmission between the clients 104(1)-104(N) and the servers 108(1)-108(M) in the network configuration 100 of FIG. 1. This or a similar process can be implemented in other network configurations.

An administrator configures 202 capacities and/or policies relating to the servers 108(1)-108(M) through the management module 124. The servers 108(1)-108(M) need not have identical capacities in terms of the number of requests each of the servers 108(1)-108(M) may simultaneously handle, in processing power, or in other ways. The management module 124 may include a user interface that enables the administrator to input the capacities and/or policies. Once configured, the program 128 can use the entered capacities and/or policies in making load balancing decisions as described further below. Although shown at the beginning of the process 200, the management module 124 may allow the administrator to configure the capacities and/or policies at other point(s) during the process 200.

One of the clients 104(1)-104(N) can request 204 information from one of the servers 108(1)-108(M). For simplicity in this example, the one of the clients 104(1)-104(N) that makes the request is referred to as the client 104. The client 104 sends an information request to the switch 106. The switch 106 may handle the information request because the servers 108(1)-108(M) may each be able to provide the same information. In such a setup, the servers 108(1)-108(M) may be considered a virtual server. When the client 104 sends an information request to the switch 106 (or to a particular one of the servers 108(1)-108(M)), the switch 106 (via the program 128) determines which of the servers 108(1)-108(M) can best handle the load of providing the information to the requesting one of the clients 104(1)-104 (N)

The switch 106 receives 206 the information request from the client 104 and the program 128 load balances 208 the information request. Load balancing involves determining which one of the servers 108(1)-108(M) should transmit the information to the client 104. The program 128 can load balance the information request by considering the actual bandwidth being used on each of the ports 110(1)-110(M) as measured by the bandwidth module 122 and the load on each of the servers 108(1)-108(M) as measured by the load monitor module 126. The program 128 can also consider any capacities and/or policies entered via the management module 124. The program 128 may also consider additional factors.

By considering the bandwidth usage, the load, the capacities, and the policies in balancing the load, the program 128 can efficiently allocate the information request to the appropriate one of the servers 108(1)-108(M) and help ensure that information requests get optimal response from one of the servers 108(1)-108(M) based on a programmable set of criteria. Such load balancing reduces the chances of under-utilizing any of the servers 108(1)-108(M) and/or the ports 110(1)-110(M). Furthermore, such load balancing reduces the chances of overloading any one of the servers 108(1)-108(M) and/or any one of the ports 110(1)-110(M).

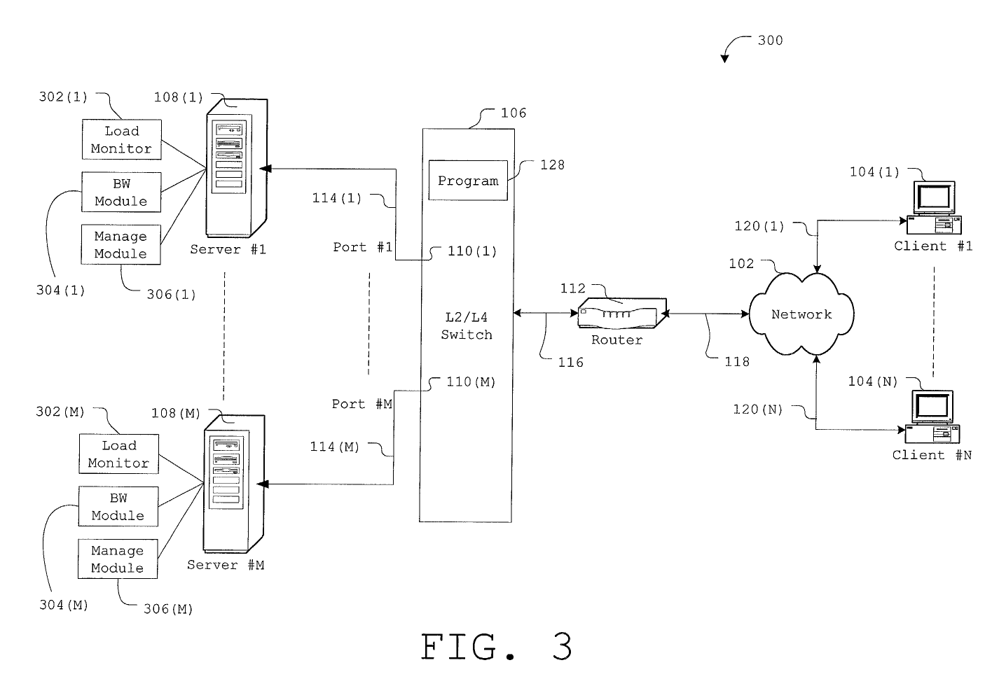

Referring to FIG. 3, a second network configuration 300 illustrates an alternate network configuration to the network configuration 100 shown in FIG. 1. The elements in the second network configuration 300 may be implemented and perform as described above for similarly named elements in FIG. 1.

In the second network configuration 300, each of the servers 108(1)-108(M) includes or otherwise has access to its own load monitor module 302(1)-302(M), bandwidth module 304(1)-304(M), and management module 306(1)-306(M). Two or more of the servers 108(1)-108(M) may share the same load monitor module, bandwidth module, and management module hosted by one of the two or more servers 108(1)-108(M). The program 128 receives information as necessary for load balancing from these modules 302(1)-302(M), 304(1)-304(M), and 306(1)-306(M).

The techniques described here are not limited to any particular hardware or software configuration; they may find applicability in any computing or processing environment. The techniques may be implemented in hardware, software, or a combination of the two. The techniques may be implemented in programs executing on programmable machines such as mobile or stationary computers, personal digital assistants, and similar devices that each include a processor, a storage medium readable by the processor (including volatile and non-volatile memory and/or storage elements), at least one input device, and one or more output devices. Program code is applied to data entered using the input device to perform the functions described and to generate output information. The output information is applied to one or more output devices.

Each program and module may be implemented in a high level procedural or object oriented programming language to communicate with a machine system. However, the programs and modules can be implemented in assembly or machine language, if desired. In any case, the language may be a compiled or interpreted language.

Each such program and module may be stored on a storage medium or device, e.g., compact disc read only memory (CD-ROM), hard disk, magnetic diskette, or similar medium or device, that is readable by a general or special purpose programmable machine for configuring and operating the machine when the storage medium or device is read by the computer to perform the procedures described in this document. The system may also be considered to be implemented as a machine-readable storage medium, configured with a program, where the storage medium so configured causes a machine to operate in a specific and predefined manner.

Other embodiments are within the scope of the following claims.

What is claimed is:

1. A method comprising:
monitoring bandwidth usage on each link between a switching device and each of a plurality of servers;
monitoring an amount of information being transmitted on each link; and
considering the bandwidth usage and the amount of information in choosing one of the servers to stream rich media information across a network to a destination.

2. The method of claim 1 further comprising receiving a request for the rich media information across the network from the destination.

3. The method of claim 1 further comprising configuring each link with service requirements.

4. The method of claim 1 in which each of the servers monitors bandwidth usage on its associated link.

5. The method of claim 1 in which each of the servers monitors the amount of information being transmitted on its associated link.

6. The method of claim 1 in which the switching device monitors bandwidth usage on each link.

7. The method of claim 1 in which the switching device monitors the amount of information being transmitted on each link.

8. An article comprising:
a machine-readable medium which contains machine-executable instructions, the instructions causing a machine to:
monitor bandwidth usage on each link between a switching device and each of a plurality of servers;
monitor an amount of information being transmitted on each link; and
consider the bandwidth usage and the amount of information in choosing one of the servers to stream rich media information across a network to a destination.

9. The article of claim 8 further causing a machine to receive a request for the rich media information across the network from the destination.

10. The article of claim 8 further causing a machine to configure each link with service requirements.

11. The article of claim 8 in which each of the servers monitors bandwidth usage on its associated link.

12. The article of claim 8 in which each of the servers monitors the amount of information being transmitted on its associated link.

13. The article of claim 8 in which the switching device monitors bandwidth usage on each link.

14. The article of claim 8 in which the switching device monitors the amount of information being transmitted on each link.

15. A system comprising:
a first mechanism configured to monitor bandwidth usage on a link between a switching device and a server;
a second mechanism configured to monitor an amount of information being transmitted on the link; and
a third mechanism configured to consider the bandwidth usage and the amount of information in choosing one of a plurality of servers, the plurality including the server, to stream rich media information across a network to a destination.

16. The system of claim 15 in which the switching device is configured to receive a request for the rich media information across the network from the destination.

17. The system of claim 15 further comprising a fourth mechanism configured to enable configurement of the link with service requirements.

18. The system of claim 15 in which the switching device includes the first mechanism.

19. The system of claim 18 in which the first mechanism is also configured to monitor bandwidth usage on each link between the switching device and each of the plurality of servers.

20. The system of claim 15 in which the switching device includes the second mechanism.

21. The system of claim 20 in which the second mechanism is also configured to monitor an amount of information being transmitted on each link between the switching device and each of the plurality of servers.

22. The system of claim 15 in which the server includes the first mechanism.

23. The system of claim 15 in which the server includes the second mechanism.

24. The system of claim 15 in which the information includes rich media.

25. The system of claim 15 in which the switching device includes a layer four switching device.
